(19) United States
(12) Patent Application Publication
(10) Pub. No.: US 2026/0264874 A1
(43) Pub. Date: Sep. 10, 2026

(54) IMPINGEMENT DETECTION SYSTEM FOR VEHICLE OPERATORS

(71) Applicants: Mordy D. Duke, Arcadia, OK (US); Russell W. White, Austin, TX (US)

(72) Inventors: Mordy D. Duke, Arcadia, OK (US); Russell W. White, Austin, TX (US)

(21) Appl. No.: 19/556,655

(22) Filed: Mar. 4, 2026

Related U.S. Application Data
(60) Provisional application No. 63/769,289, filed on Mar. 10, 2025.

(51) Int. Cl. B64D 43/00; B64D 31/06; B64D 45/00; F02P 11/02

(52) U.S. Cl. CPC B64D 43/00; B64D 31/06; B64D 45/0005; F02P 11/02

(57) ABSTRACT

An impingement detection system for vehicle operators is disclosed. In practice, an impingement detection system may include a sensor that is configured to recognize if a potential impingement, such as an airplane tow bar, landing gear wheel chocks, etc., is located within a potentially hazardous area, such as the rotational pathway of an operating propeller. In an attempt to avoid a potential propeller strike or other issue, an alarm may be communicatively coupled to the sensor and configured to indicate the potentially dangerous situation if and/or when the sensor recognizes the potential existence of the problem. Depending upon design concerns, such a system may utilize a visual alarm, an audible alarm, a haptic alarm, some combination of modalities, etc. Moreover, the system may focus the alarm on operators or personnel already within a vehicle, personnel outside the vehicle, both of these, and/or some other combination or individual.

### CROSS-REFERENCE TO RELATED APPLICATION

This application claims the benefit of U.S. Provisional Application No. 63/769,289, filed on Mar. 10, 2025, and entitled “IMPINGEMENT DETECTION SYSTEM FOR VEHICLE OPERATORS.”

### TECHNICAL FIELD

The following disclosure relates to detection systems, and more particularly to an impingement detection system for vehicle operators.

### BACKGROUND

Operating vehicles, whether boats, automobiles, airplanes, etc., can be a difficult task. Frequently, the operator is managing several mentally engaging tasks at the same time. It can be easy to forget to check on or consider one or more of these tasks. This is especially true in high stress moments or in highly complex vehicles like airplanes. Moreover, despite a vehicle designer's best efforts, there are frequently areas around a given vehicle that the operator cannot actually see or see well during operation. If something makes its way into a dangerous or potentially damaging area or was accidentally left in such an area, the operator may not be aware of the potential danger. As such, there exists a need for an impingement detection system for vehicle operators.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an impingement detection system that incorporates teachings of the present disclosure;

FIG. 2A illustrates an example sensor device that may be used in a system that incorporate teachings of the present disclosure;

FIG. 2B illustrates an example sensor device that may be used in a system that incorporate teachings of the present disclosure;

FIG. 3 illustrates other sensing devices within a system incorporating teachings of the present disclosure; and

FIG. 4 illustrates a user interface and presentation system incorporating teachings of the present disclosure.

### DETAILED DESCRIPTION

The following discussion is intended to provide one skilled in the art with various teachings that can be combined and/or separated to create useful and desirable products. The teachings may be employed within a variety of settings. While there may be any number of systems and situations in which a user may elect to utilize some of the teachings disclosed herein, the following detailed discussion focuses on an impingement detection system for airplane pilots. The figures and discussion will focus on smaller, private, single-engine and multi-engine aircraft, but the teachings may be applied far beyond this focusing. The focus is offered in an effort to provide a clear and concise teaching without limiting the scope of the teaching.

From a high level, an impingement detection system might include a sensor that is configured to recognize if a potential impingement, such as an airplane tow bar, landing gear wheel chocks, etc., is located within a potentially hazardous area, such as the rotational pathway of an operating propeller. In an attempt to avoid a potential propeller strike or other issue, an alarm may be communicatively coupled to the sensor and configured to indicate the potentially dangerous situation if and/or when the sensor recognizes the potential existence of the problem. Depending upon design concerns, space limitations, etc., a designer may utilize a visual alarm, an audible alarm, a haptic alarm, some combination of modalities, etc. Moreover, the designer may focus the alarm on pilots or personnel already within the airplane and/or cockpit, personnel outside the aircraft, both of these, and/or some other combination or individual.

As will be discussed more in connection with the Figures, a designer may utilize pressure switch sensors, electrical short sensors, infrared sensors, cameras, ultrasound sensors, laser-based sensors, some other form of sensors, and/or combinations of sensor types. Similarly, a designer may use one, two, or more sensors to provide additional information, redundancy, different views, etc.

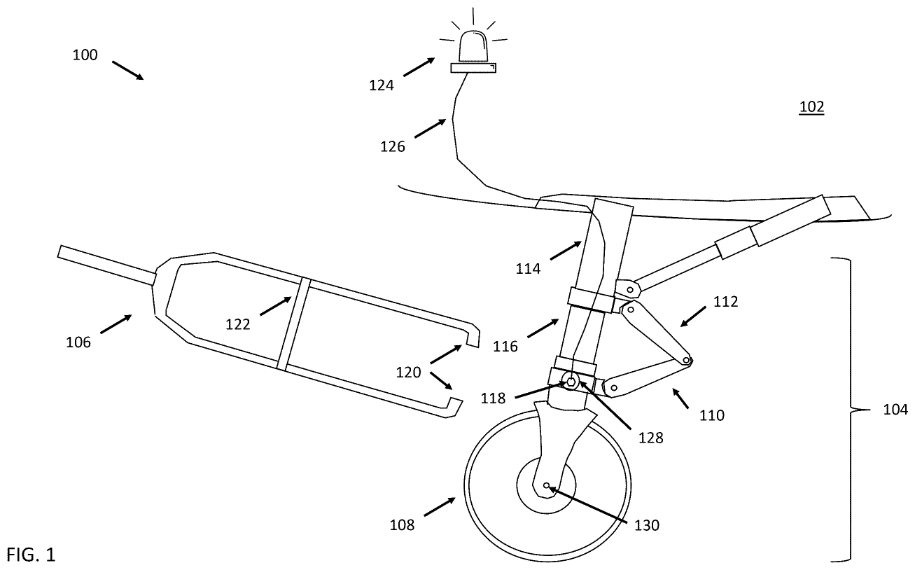

As mentioned above, FIG. 1 illustrates an impingement detection system 100 that incorporates teachings of the present disclosure. System 100 is focused on recognizing the existence of a tow bar within the potential rotational path of a spinning propeller. In practice, propeller strikes (when an aircraft propeller hits something it shouldn't hit while it's rotating) is an all too common cause of insurance claims for small, private aircraft. And, a propeller strike involving a tow bar that was left connected to the aircraft is a common cause of propeller strikes. In practice, a pilot may simply forget to remove the tow bar prior to climbing into the cockpit. At this point, the pilot can no longer see the area where the tow bar is and can easily initiate ignition of the aircraft and drive the propeller into the still-connected tow bar.

As shown in FIG. 1, an aircraft fuselage 102 is depicted above a landing gear 104. Additionally, a tow bar 106 is shown. Landing gear 104 includes a landing gear wheel 108, a lower torque link 110, and upper torque link 112, an upper strut 114, and a lower strut 116. Additionally, a nose gear strut lug 118 is depicted. For many small aircraft, this lug 118 has a ⅝″ bolt head on either side and acts as the attachment point for a tow bar, like tow bar 106. In practice, tow bar cups 120 are sized to fit over the bolt heads of lug 118. And, a tightening link, like tightening link 122, may be operated to “pinch” cups 120 firmly onto lug 118. Once connected and tightened, tow bar 106 may be used to pull and push an aircraft around and into a desired position and/or location.

Also depicted in FIG. 1 is a cockpit alarm 124 that is communicatively coupled via communicative coupling wires 126 to sensor 128. A designer may choose to use wires to communicatively couple a sensor and an alarm. A designer may also use wireless signaling or some other methodology as well. For example, if a designer elects to use a short-range wireless technology to communicatively couple alarm 124 and sensor 128, the designer may choose, for example, Bluetooth, Wi-Fi, ZigBee, UWB, ANT, etc. However coupled, a designer may want alarm 124 to illuminate a warning light, sound an audible alarm, vibrate a yoke or stick, or some combination of these notifications when sensor 128 indicates that tow bar 106 is still potentially within a rotational pathway of a propeller, the pathway of wheel 108, and/or in some other potentially dangerous location, whether attached to landing gear 104 at lug 118 or nose wheel axle lug 130, or in some other potentially dangerous location.

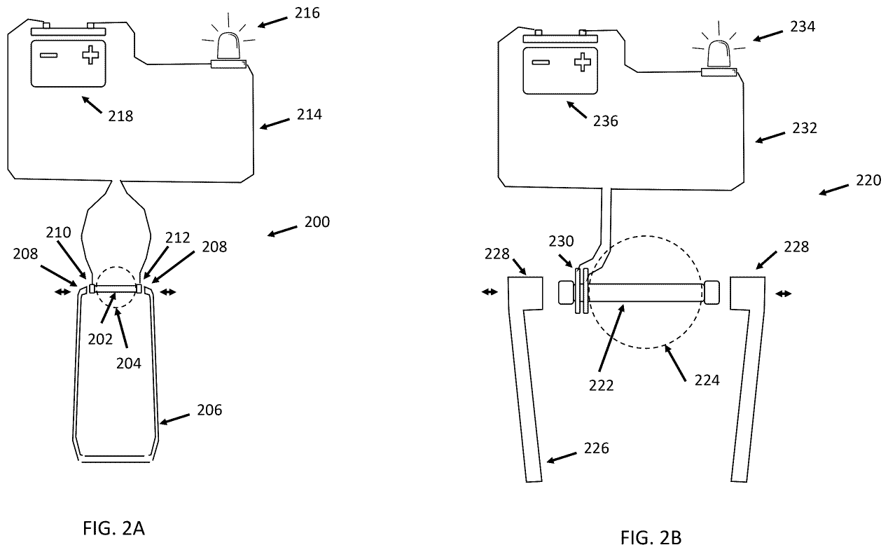

As mentioned above, FIG. 2A and FIG. 2B illustrate example sensor devices that may be used in a system that incorporate teachings of the present disclosure. Shown in FIG. 2A is a system 200 that includes a nose gear lug bolt 202 extending through a lower strut 204. In practice, a tow bar 206 with tow bar cups 208 may be pinched onto lug bolt 202. Also depicted is negative contact 210 and positive contact 212 for a switch-based sensor depicted in system 200. Operationally, circuit wiring 214 creates a loop that runs through alarm 216 and is powered by power source 218. As depicted, power source 218 may be a DC power source and may be a battery used within an aircraft that has a landing gear like the one depicted in FIG. 1.

In use, negative contact 210 and positive contact 212 may be electrically isolated from one another in a manner that creates an open circuit. When tow bar 206 is attached to lug bolt 202 and tow bar cups 208 are pinched firmly into place, tow bar 206 may complete the circuit allowing alarm 216 to be powered and to provide an indication to a pilot and/or someone else that tow bar 206 is still attached to the plane's landing gear. As such, system 200 may notify a pilot that a potential impingement exists and need to be redressed.

Similarly, FIG. 2B depicts a system 220 that includes a nose gear lug bolt 222 extending through a lower strut 224. In practice, a tow bar 226 with tow bar cups 228 may be pinched onto lug bolt 222. Also depicted is pressure switch 230. Operationally, circuit wiring 232 creates a loop that runs through alarm 234 and is powered by power source 236. As depicted, power source 236 may be a DC power source and may be a battery used within an aircraft that has a landing gear like the one depicted in FIG. 1.

In use, pressure switch 230 may create an open circuit when the switch is not compressed. When tow bar 226 is attached to lug bolt 222 and tow bar cups 228 are pinched firmly into place, tow bar 226 may compress pressure switch 230, which may complete the circuit allowing alarm 234 to be powered and to provide an indication to a pilot and/or someone else that tow bar 226 is still attached to the plane's landing gear. As such, system 220 may notify a pilot that a potential impingement exists and need to be redressed.

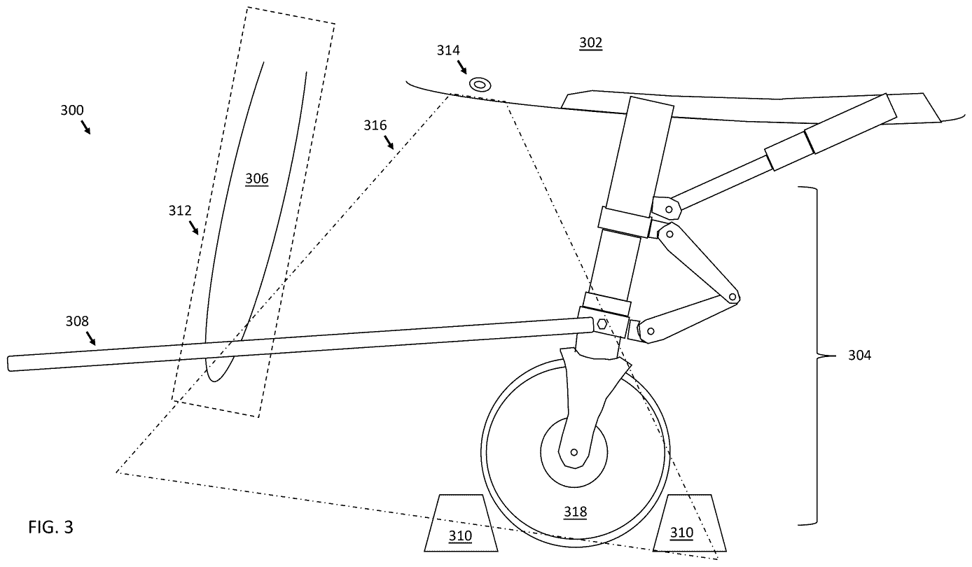

As mentioned above, FIG. 3 illustrates other sensing devices within a system incorporating teachings of the present disclosure. As shown, system 300 is depicted with an aircraft fuselage 302, landing gear 304, and propeller blade 306. FIG. 3 also shows a couple of potential impingements as well, including an attached tow bar 308 and wheel chocks 310.

A rotating propeller blade pathway 312 is depicted as surrounding blade 306. Pathway 312 is shown in two dimensions, but it may also be understood as rotating around the propeller shaft such that pathway 312 appears as a three-dimensional disk having a thickness. Depending upon design concerns, a system like system 300 may make use of artificial intelligence (AI) to learn or develop an understanding of where pathway 312 is relative to other physical elements of an aircraft as well as how large pathway 312 is. In practice, system 300 may create a virtual representation of pathway 312 with some amount of safety factor, such as one inch beyond an actual pathway, six inches beyond an actual pathway, etc. such that the virtual pathway created for purposes of impingement detection is actually a little larger than the actual pathway of an airplane's rotating propeller. The creation of the virtual representation may be done through a process of installing a sensor, calibrating the sensor's distance measurements, rotating a propeller such that the sensor “sees” the pathway, calculating an appropriate virtual pathway with and/or without a safety factor, and saving the pathway in a memory associated with system 300. FIG. 3 shows a sensor 314 mounted to fuselage 302 in a position that allows sensor 314 to “see” a cone 316 of area under fuselage 302. This may be the sensor utilized during a learning process or pathway creation process. In practice, sensor 314 may be an infrared sensor, a laser-based sensor, an ultrasonic sensor, an optical camera sensor, a combination of sensors, etc.

For example, if sensor 314 combines an optical sensor and an ultrasonic sensor, system 300 may be able to show a visual image of the area under fuselage 302 to a pilot within the cockpit while also indicating if something within cone 316 is within a potentially dangerous impingement zone. For example, an ultrasonic sensor capable of measuring distance and direction from sensor 314 may indicate that tow bar 308 is within pathway 312. Similarly, sensor 314 may indicate to a pilot that wheel chocks 310 have not been removed and would interfere with the movement of wheel 318 should the pilot attempt to begin taxiing.

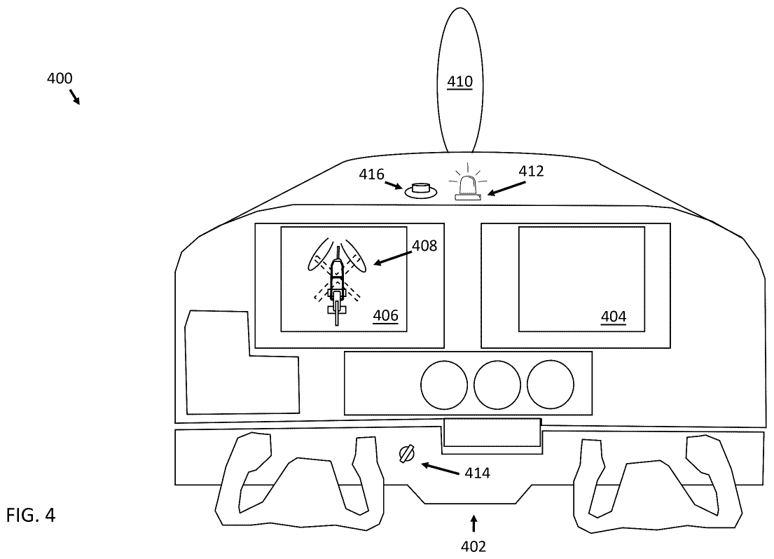

As mentioned above, FIG. 4 illustrates a user interface and presentation system 400 incorporating teachings of the present disclosure. As depicted, cockpit 402 includes a glass cockpit implementation with two large display screens, screen 404 and screen 406. Depicted on screen 406 is a camera view 408 showing landing gear, two propeller blades, an attached tow bar, and wheel chocks that have not been removed. In practice, view 408 may be a live view of underneath the fuselage. For example, a sensor like sensor 314 may be capturing and communicating the image data for presentation on screen 406. Also depicted within view 408 is a superimposed “X” on top of the camera view. The “X” may assist a pilot in recognizing that there are potential impingements remaining under the plane where the pilot cannot readily see them. For example, a virtual representation of a pathway, like pathway 312, may be saved in memory, and system 400 may access this information to determine if anything, such as tow bar 308 impinges on the pathway. If it does, system 400 may initiate an alarm as well as illuminating the “X” within view 408.

As the pilot looks out the front window of the plane, the pilot may see one or more propeller blades 410, but in many cases, the pilot will not be able to see much more than that. As such, a system incorporating teachings of the present disclosure may elect to have multiple alarms like the “X” and siren 412, which may include both a flashing light and an audible alarm. In practice, these alarms may notify the pilot of a potential problem. Depending upon design concerns, the sensors and alarms may be wired directly to the battery of the plane. The sensors and alarms may also be wired to the battery in a manner that does not power the sensors and alarms until the ignition key 414 is turned to an “On” position. In some embodiments, the alarms may be wired such that an active alarm will disallow the pilot from turning the engine over and beginning the rotation of the propeller. In such a system, a designer may elect to include an alarm override button 416 that would allow the pilot to depress button 416 and “start” the engines even in an active alarm scenario. Such an option may be necessary as pilots occasionally need to do restarts during flight and a faulty active alarm would need to be overridden.

The teachings disclosed herein are intended to allow one skilled in the art to understand an impingement detection system. A designer may utilize the teachings to create an after-market system that may be added, for example, to an existing plane. Similarly, an original equipment manufacturer may include such a system on a plane. For example, Cessna, Cirrus, Beechcraft, Piper, etc. may incorporate a system like, for example system 300, into new aircraft. In practice, a company like Garmin may be involved to facilitate a designer's ability to present information to a pilot in a cockpit like the cockpit depicted in FIG. 4. As such, a system incorporating teachings of the present disclosure may include one or more sensors of the same or different types, software and/or coding sufficient to facilitate communication and presentation of sensed information, alarms, displays, electric connectivity for power, connectivity for communication, warning indicators, warning overrides, buttons, touch screens and/or switches to access, utilize, control the system, etc. If cameras are utilized, such cameras could include fish eye lenses, optical zoom lenses, 4k resolution, more or less resolution, etc. Similarly, a graphical user interface or other interface mechanism may allow for accessing camera features such as pan, tilt, zoom, etc. Moreover, such an interface may facilitate a calibration of the system to help ensure distance measurements and/or awareness is accurate. Similarly, such an interface may assist in “creating” an understanding of the location of a rotating blade or other relevant moving part pathway.

To be clear, a designer may choose to create a system that uses all or some of the above teachings in various configurations. The above description teaches several aspects in a complete and yet succinct way. A designer will recognize that he or she can take a teaching, for example, from FIG. 1 and combine it with a teaching from, for example, FIG. 3. A system incorporating teachings of the present disclosure may replace, add, or delete many of the above-described features and components without departing from the scope of the disclosure. One skilled in the art will recognize that many of the above-described components could be combined or broken out into other combinations.

Although the present invention has been described in detail, it should be understood that various changes, substitutions and alterations to the devices, methods, and other aspects and techniques of the present invention can be made without departing from the spirit and scope of the invention as defined by the appended claims.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An impingement detection system comprising:
a sensor configured to recognize a potential existence of an airplane tow bar located within a rotational pathway of a propeller; and
an alarm communicatively coupled to the sensor and configured to indicate a potential propeller strike situation in response to the sensor recognizing the potential existence of the airplane tow bar within the rotational pathway of the propeller.

2. The impingement detection system of claim 1, wherein the sensor comprises one or more of an infrared sensor, a laser-based sensor, an ultrasonic sensor, or an optical sensor.

3. The impingement detection system of claim 1, wherein the sensor comprises first and second contacts to complete a circuit when the airplane tow bar is connected to the airplane, wherein when the circuit is completed, the alarm is to indicate the potential propeller strike situation.

4. The impingement detection system of claim 1, wherein the sensor comprises a switch to complete a circuit when the airplane tow bar is connected to the airplane, wherein when the circuit is completed, the alarm is to indicate the potential propeller strike situation.

5. The impingement detection system of claim 1, wherein the sensor is to provide an image of at least a portion of the rotational pathway of the propeller.

6. The impingement detection system of claim 1, further comprising an artificial intelligence model to define a virtual representation of the rotational pathway of the propeller.

7. The impingement detection system of claim 6, wherein the artificial intelligence model is to indicate the potential propeller strike situation based, at least in part, on the virtual representation of the rotational pathway of the propeller.

8. The impingement detection system of claim 1, wherein the alarm comprises a display to display an image of at least a portion of the rotational pathway of the propeller.

9. The impingement detection system of claim 8, wherein the display is to output a notification to a pilot in response to the sensor recognition of the potential existence of the airplane tow bar within the rotational pathway of the propeller.

10. The impingement detection system of claim 1, wherein the sensor is wirelessly coupled to the alarm.

11. The impingement detection system of claim 1, wherein the alarm is configured to indicate the potential propeller strike situation with a multi-modal notification including a visual notification presented on a display and an audible notification.

12. A system comprising:
at least one sensor configured to recognize when an object is located within a rotational pathway of a propeller of an airplane; and
an alarm communicatively coupled to the at least one sensor and configured to indicate a potential propeller strike situation in response to the at least one sensor recognizing when the object is located within the rotational pathway of the propeller.

13. The system of claim 12, wherein the at least one sensor comprises at least one image sensor adapted to a fuselage of the airplane to capture image data of at least a portion of the rotational pathway of the propeller.

14. The system of claim 13, wherein the alarm comprises a display to display the image data.

15. The system of claim 14, wherein the display is operable to output a notification to a user when an object is located within the rotational pathway of the propeller of the airplane.

16. The system of claim 12, wherein the sensor comprises a first and a second electrical contact configured to facilitate a completing of a circuit when an airplane tow bar is connected to the airplane, wherein when the circuit is completed, the sensor recognizes that the tow bar is located within the rotational pathway of the propeller of the airplane.

17. The system of claim 12, wherein the alarm is configured to indicate the potential propeller strike situation with a multi-modal notification including a visual notification presented on a display and an audible notification.

18. A method comprising:
detecting, via at least one sensor, a potential existence of an airplane tow bar within a rotational pathway of a propeller; and
in response to detecting the potential existence of the airplane tow bar located within the rotational pathway of a propeller, issuing an alarm signal to indicate a potential propeller strike situation.

19. The method of claim 18, wherein the sensor comprises a circuit, and the method further comprises completing the circuit when the airplane tow bar is connected to the airplane.

20. The method of claim 18, wherein issuing the alarm signal comprises:
outputting a multi-modal notification to at least one individual in response to detecting the potential existence of the airplane tow bar within the rotational pathway of the propeller; and
disallowing an igniting of an engine to initiate rotation of the propeller without an action acknowledging the alarm by the at least one individual.
